(19) United States
(12) Patent Application Publication
(10) Pub. No.: US 2015/0052553 A1
(43) Pub. Date: Feb. 19, 2015

(54) System and Method for Media on a Social Network

(71) Applicants: Glenn Carnahan, Auburn, CA (US); Douglas Stanley, Auburn, CA (US)

(72) Inventors: Glenn Carnahan, Auburn, CA (US); Douglas Stanley, Auburn, CA (US)

(21) Appl. No.: 14/459,272

(22) Filed: Aug. 13, 2014

Related U.S. Application Data
(60) Provisional application No. 61/865,916, filed on Aug. 14, 2013.

(51) Int. Cl. H04N 21/2665; H04N 21/472; H04N 21/478; H04N 21/4782; H04N 21/2668; H04N 21/254; H04N 21/643; H04N 21/81; H04N 21/4788

(52) U.S. Cl. CPC H04N 21/2665; H04N 21/812; H04N 21/47211; H04N 21/47815; H04N 21/4788; H04N 21/2668; H04N 21/254; H04N 21/2542; H04N 21/64322; H04N 21/4782
USPC 725/34; 725/109; 725/104; 725/60

(57) ABSTRACT

The proposed invention is a 3^{rd} party provided multimedia platform designed to link an application driven media player within a social media website landing page. The Platform is administered by a third party server and provides the user of a social media website access to multimedia content along with integrated access to other social media users through mechanisms such as chat rooms. The Platform integrates chat and metadata management to allow clients to provide integrated multimedia feeds to users. Clients may engage and interact with users of provided media in directed dynamic communications (including advertising and other mechanisms) directed by data analysis of trends in communication and behavior that develop dynamically over the course of media broadcasts.

### RELATED APPLICATION

This invention claims the benefit of the prior filed Provisional Application No. 61/865,916 titled “Social Interactive Dynamic Video Platform”, filed on Aug. 14, 2013, the contents of which are incorporated herein by reference on their entirety for all purposes.

### BACKGROUND

1. Technical Field

This invention is directed to a web-enabled video platform for the broadcast of interactive video media.

2. Background Information

Traditionally video media has been provided by broadcast television networks, or cable television providers. Viewers made selections from scheduled broadcasts that could be watched live, or recorded for future viewing. This evolved to include ordering “on demand” pre-recorded video content that could be watched at the viewers' convenience, along with personal video recorders that allowed consumers to record media for future use. This was, in essence, a unidirectional media system where the broadcaster actively provided content and the viewer passively watched and/or listened to it. The information the broadcasters retrieved in response from viewers was primarily through modeling based on the Nielson system where a statistical model of viewership was built based on the viewing habits of a fraction of the population, or through independent surveys of focus groups.

The Internet has opened a new medium for providing video media to consumers, and for providers to interact directly with them. Through computing platforms, digital video data may be stored and broadcast via the World Wide Web to a broad audience. The number of people accessing the content may be directly recorded and analyzed. Video may also be broadcast via portals within other existing Internet sites. This provides producers of media content the opportunity to leverage the utility of certain types of Internet sites such as social media to help promote the popularity of media content. This new technology provides broadcasters the opportunity to satisfy heretofore-unrealized desires/needs for producers and consumers of Internet media content to interact and create a more responsive, immersive and engaged media system. However, this new technology has previously been focused on a unidirectional system where media is provided, and some resulting information recorded. The benefits of an interactive media and discussion oriented platform with dynamic data analysis provides heretofore unrealized benefits to producers and consumers, and the present invention provides such a platform.

3. Description of the Related Art

The dissemination of video content through the Internet has spread across the globe.

Sites such as YouTube and other websites provide viewers with a gateway to millions of videos. Providers capture limited information such as the number of times a video has been viewed and various other metrics that may include linking the viewership to user profiles on social networking sites such as Facebook. Social networking and email services also offer the opportunity to introduce material, and provide links to the material, to people they are associated with. There is a need, however, by producers (and a benefit to consumers) for the linked media to be more interactive allowing for a closer and more focused producer-consumer relationship.

The present invention of a media player within a network, such as a social media network, integrated with real time chat/discussion, other features and dynamically responsive data analysis will enable the present inventors to provide numerous benefits to both the producers and consumers of media content as provided by the present invention.

### SUMMARY

One embodiment of the present invention is a computer-implemented system in a client-server environment. This system provides a media player designed to be embedded in, or accessed from a landing page, such as a home page, within a website, and managed by a third party server provided by the present invention. A preferred embodiment is designed to provide a link to a media player within the landing page of a social media network website. This media player, in a preferred embodiment, is configured with an integrated chat room so that the user may comment on the media (which may be video, audio or any combination thereof). These comments may be made in real time and directed laterally to members of their social network, or vertically to the producer of the media. The chat features may be further segregated to allow large/public chats or small/private chats. This real time chat further facilitates the sharing of the media content across the user's social media network. It also provides the opportunity for the user to communicate vertically with the producer of the media content, facilitating information that the producer (or provider of the present invention) may use to improve content and direct other content such as video tags, promotions, products or advertisement to the user. Traditionally the vertical producer to user/consumer chat in this relationship has been a one to many design, however the present invention also provides the ability for one on one private chat mechanisms between the producer and consumer which creates value for both parties by providing important feedback and metrics to the producer and the opportunity for the consumer to receive recognition and rewards for their participation. Dynamic analysis of the data generated by chat, viewing habits and other metrics provides the system with the important ability to actively or passively respond in ways that benefit the producer and the consumer that have not been previously available.

In another aspect of the invention the client, or producer, is able to utilize customizable pages integrated into the media player. These pages may be designed to customize the appearance of the media player along with features such as recommended content, product placement along with a mechanism for purchasing or placing orders by the user with the producer.

In a further aspect of the invention, the media player is designed to allow the producer to broadcast multiple feeds simultaneously. These feeds may be separate individual broadcasts or a main broadcast along with related sub-broadcasts. The related broadcasts may be scaffolded (e.g. the client producer may broadcast a sporting event with sub-broadcasts focused on individual entrants and then sub-sub-broadcasts for each of the sponsors of each of the entrants). Chat features can be integrated for crossover discussion between different feeds or extend outside to members of the user's social network.

An important element of the present invention is the integration of responsive dynamic data analysis of the data obtained from user-generated metrics relating to the various features of the present invention. This may provide users with such benefits as increased access to their interests a more immersive media experience, and providing the client producer with directed dynamic communications that may include such things as targeted promotions and advertisements, suggested alternative content and potential likeminded contacts. These dynamic communications may be directed by the collection and analysis of metadata that may include such data as user profiles, dynamic trends and other information that develop over the course of a broadcast and the corresponding communications between users or the users and the producers of the content.

The features and advantages described herein are not all-inclusive and, in particular, many additional features and advantages will be apparent to one of ordinary skill in the art in view of the drawings, specification, and claims. Moreover, it should be noted that the language used in the specification has been principally selected for readability and instructional purposes, and not to limit the scope of the inventive subject matter.

### BRIEF DESCRIPTION OF THE DRAWINGS

The present invention is illustrated by way of example and not limitation in the figures of the accompanying drawings, in which like references indicate similar elements and in which:

FIG. 1 is a block diagram of one embodiment of the relationship between the 3^{rd} party servers and a social media landing page;

FIG. 2 is a block diagram of one embodiment of the relationship between the 3^{rd} party servers and a social media landing page;

FIG. 3 is a block diagram of one embodiment of the relationship between the 3^{rd} party servers and a social media landing page;

FIG. 4 is a block diagram of one embodiment of the relationship between the 3^{rd} party servers and a social media landing page;

FIG. 5 is a block diagram of one embodiment of the relationship between the 3^{rd} party servers and a social media landing page;

FIG. 6 is a block diagram of one embodiment of the relationship between the client and a social media landing page;

FIG. 7 is a block diagram of one embodiment of the relationship between the 3^{rd} party servers and a social media landing page;

### DETAILED DESCRIPTION

In the following detailed description, reference is made to the accompanying drawings that form a part hereof, and in which is shown by way of illustration, specific embodiments in which the invention may be practiced. These embodiments are described in sufficient detail to enable those skilled in the art to practice the invention, and it is to be understood that other embodiments may be utilized. It is also to be understood that structural, procedural and system changes may be made without departing from the spirit and scope of the present invention. In addition, well-known structures, circuits and techniques have not been shown in detail in order not to obscure the understanding of this description. The following detailed description is, therefore, not to be taken in a limiting sense, and the scope of the present invention is defined by the appended claims and their equivalents.

### General Overview

A preferred embodiment of the present invention provides a media player integrated into a web page that produces audio and/or video media with the ability for producers and users to chat laterally and vertically with each other. The invention provides media and chat capabilities while dynamically analyzing the data produced by these communications and responding by directing/refining further communications, options and features provided by the media player. The media player may be further configured to allow for multiple simultaneous broadcasts including tiered or scaffolded broadcasts where a primary broadcast may lead the viewer to successive sub-broadcasts allowing the user a more immersive experience of the broadcast event. The media player may also be customized to provide various economic features such as product placement and advertising or commerce features such as the ability to purchase from producers or redeem promotions. Such an embodiment provides producers and users an interactive commerce and communication platform that have not been available before and which provide numerous benefits to both the producer and user.

### TERMINOLOGY

For the purposes of the present specification, the term “provider” shall be taken to include the manager of the third party servers that direct the functionality of the media player of the present invention. The term “producer” shall be taken to include the clients of the provider who produce audio/video media material and transmit such material through the provider's media platform. The term “user” or “consumer” shall be taken to refer to any receiving viewer of the media transmitted and end user of the media platform. The term “chat” may include text or video chat such as that available through Skype. The term “transaction” shall be taken to include any communications between two or more entities and shall be construed to include, but not be limited to, various individual steps associated with exchanging goods, services or data. The term “landing page” shall be taken to refer to any window within a web platform that is specific to a particular user (e.g. the home page of a subscriber to a social networking website). The term “linked” is used to convey in the conventional sense modules, servers, landing pages and other elements of the described system that are communicably coupled with each other through the design of the present invention, the Internet or other data driven means. The term “media” or “media content” may be used interchangeably to refer to audio, visual and other content as that provided by media platforms such as newspaper and broadcast television along with the type of content transmitted by Internet media (a common example being videos).

As used herein, the term “computer” is meant to encompass a workstation, personal computer, personal digital assistant (PDA), Smartphone on a cellular telephone or Wi-Fi network, or any other suitable computing device including a processor, a computer readable medium upon which computer readable program code (including instructions and/or data) may be disposed with a user interface. Terms such as “server”, “application”, “engine” and the like are intended to refer to a computer-related component, including hardware, software, and/or virtual computing services such as cloud computing. For example, a server may be, but is not limited to being, a process running on a processor, a processor including an object, an executable, a thread of execution, a program, and a computer. Moreover, the various components may be localized on one computer and/or distributed between two or more computers. The terms “real-time” and “on-demand” refer to sensing and responding to external events nearly simultaneously (e.g., within milliseconds or microseconds) with their occurrence, or without intentional delay, given the processing limitations of the system and the time required to accurately respond to the inputs.

Terms such as “component,” “module,” and the like are intended to refer to a computer-related entity, either hardware, a combination of hardware and software, software, or software in execution. For example, a module may be, but is not limited to being, a process running on a processor, a processor, an object, an executable, a thread of execution, a program, and a computer, server, or sub-element of a software system managed by a computer or server system. By way of illustration, both an application running on a server and the server may be modules. One or more modules may reside within a process and/or thread of execution and a module may be localized on one computer and/or distributed between two or more computers or control devices.

### Programming Languages

The systems and methods embodying the present invention can be programmed in any suitable language and technology, such as, but not limited to: Ruby; C++; Visual Basic; Java; VBScript; Jscript; BCMAscript; DHTM1; XML and CGI. Alternative versions may be developed using other programming languages including, Hypertext Markup Language (HTML), Active ServerPages (ASP) and Javascript. Any suitable database technology can be employed, such as, but not limited to, Microsoft SQL Server or IBM AS 400.

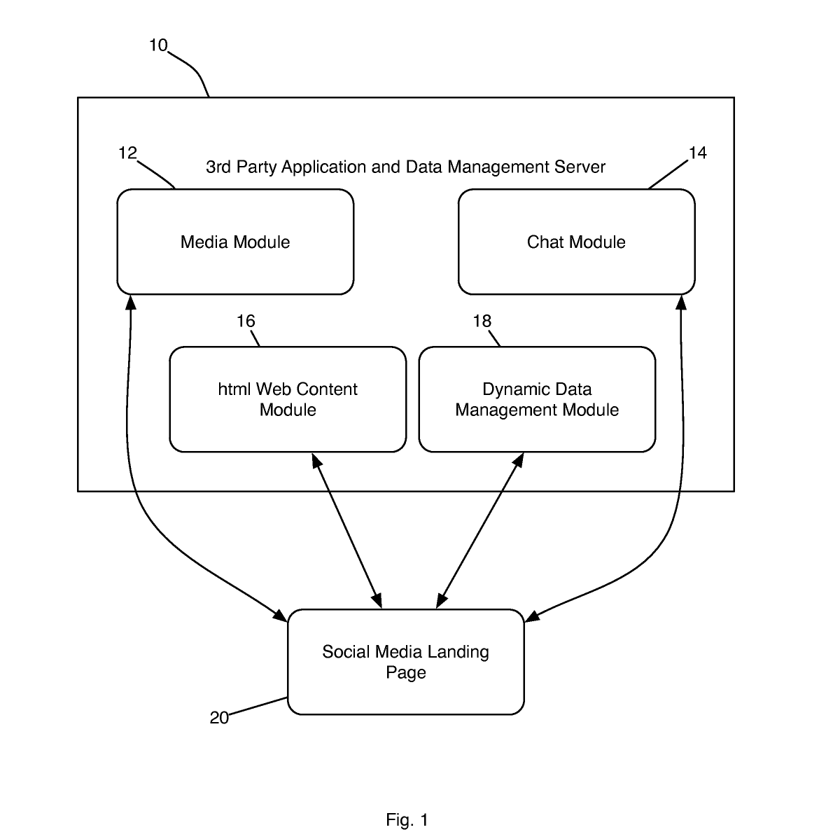

Referring now to FIGS. 1-7, embodiments of the present invention will be more thoroughly described.

FIG. 1 is a block diagram of one preferred embodiment of the invention that illustrates the relationship between the 3^{rd} party application 10 and a social media landing page 20. The system is designed to provide html web content 16 that provides a link within the users social media landing page 20. The linked 3^{rd} party application and data management server 10 is designed to provide an audiovisual media player through a media module 12, which is integrated with chat services provided by a chat module 14. Media content from the media module 12 within the 3^{rd} party system 10 streams media content to the social media landing page 20 and may also receive media content from the landing page 20. Similarly the chat module 14 is linked to the social media landing page 20. The media module 12, chat module 14 and html web content module 16 are also in communication with an active or passive dynamic data management module 18. The dynamic data management module 18 is designed to monitor and evaluate data obtained through the modules linked to the social media landing page 20 or directly from the landing page 20. The data may consist of specific data points such as a user's age or it may consist of trends or other algorithmic evaluations of user behavior along with consequential data such as secondary effects such as shifts in consumption of a clients products.

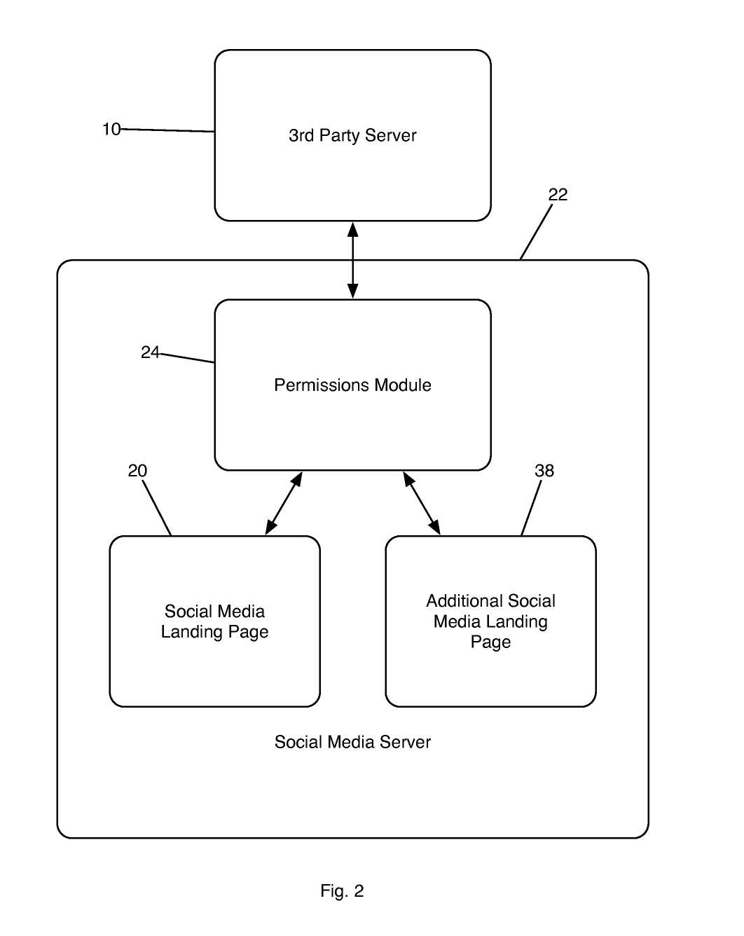

FIG. 2 illustrates one approach to linking the media player within the social media landing page 20 that resides within a social media server 22 such as a platform like Facebook. A user with a social media landing page 20 on a social network such as Facebook desires access to the present invention on their landing page 20. The user elects through a permissions module 24 to give the application permission to run on their landing page 20. The process is repeated for any new user. Subsequent chat linked social media landing pages also allow the third party server 10 access to their landing pages 38 through the permissions module 24. Once the third party server 10 has access to both the social media landing page 20 and additional social media landing pages 38 the third party server 10 is able to facilitate chat, media sharing and other features associated with the present invention across the network of linked landing pages.

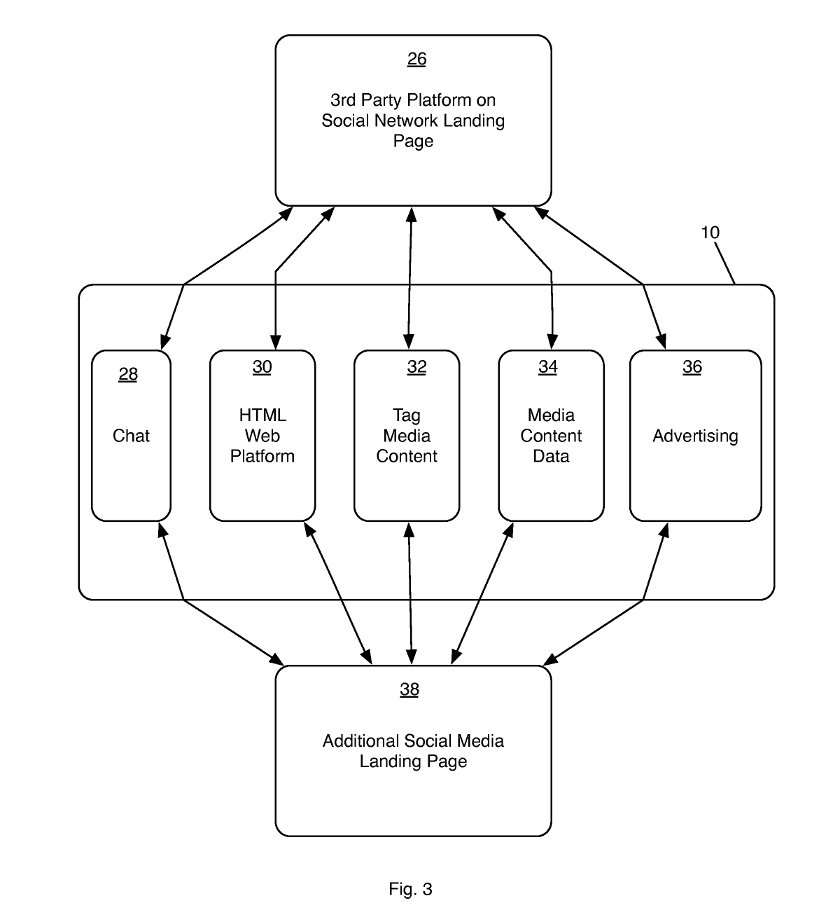

As we can see on FIG. 3 the 3^{rd} party platform on a Social Network Landing page 26 can facilitate numerous features between that platform and additional social media landing pages 38 through the third party platform 10. FIG. 3 illustrates a non-exclusive sampling of the features that may be provided in one embodiment of the present invention. As previously mentioned chat 28 is integral to the design of the present invention allowing the client or producers of media content to disseminate their content by passing it through the third party application and data management server 10 which then provides it to user's social media landing page 20 through the 3^{rd} party platform on the social networking landing page 26. By chatting 28 and tagging media content 32 the user can share media content with additional pages 38 through the html web platform 30 that has been permitted to run on the linked pages. This facilitates dissemination of the media producers content through out the social network controlled by the social media server 22. Data moves in both directions through the network of users and producers so that it can be analyzed and dynamically reacted to by the 3^{rd} party application and data management server's 10 dynamic data management module 18. This allows, among other things, for the producer of the content to focus directed advertising 36 to the most appropriate audience. Advertising for a producer client may be focused on their particular audience or directed to other broadcasts by other producers. The analysis of data produced from chat, viewing patterns and other metrics may also be used to generate suggestions for other viewing content, direct promotions, change the background of the html web platform 30 or the makeup of the 3^{rd} party platform on the social media landing page 26. The chat 28 as well as other media sharing may occur between linked user pages through the 3^{rd} party server 10 of the present invention, or may also continue vertically up to the 3^{rd} party provider of the system or directly to the producer client of the 3^{rd} party provider through the 3^{rd} party server 10 of the present invention. Chat may also be provided in a group or private setting.

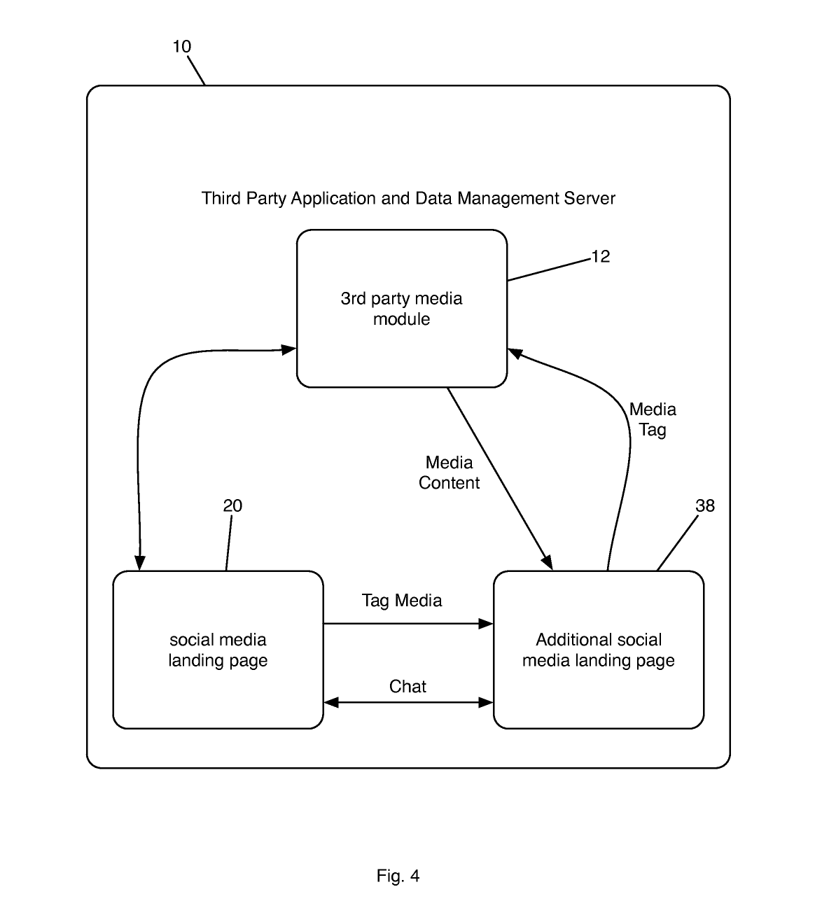

FIG. 4 illustrates, in one embodiment, the relationship between the provider of the invention's 3^{rd} party media module 12 to multiple landing pages 20 & 38. The 3^{rd} party media server initiates contact with a social media landing page 20 that through the permissions module 24 allows the media module 12 to stream media content to the landing page 20. The user of that landing page then initiates contact with another landing page 38 linking them. The user of the additional landing page 38 embeds the media player through the permissions module 24 allowing the media module 12 to then stream media content to the additional page 38. At this point the media module 12 has access to multiple landing pages and can stream media content to each individually. FIG. 4 further illustrates one example of how data such as displayed in FIG. 3 may be generated and passed among a network of additional landing pages 38 and back to the media module 12. In this illustration a user through the platform linked to their landing page 20 tags a section of media content streaming from the provider's media module 12. The tagged media content may then be shared with an additional landing page 38 via the 3^{rd} party server 10 or other platforms such as Facebook, Twitter etc. . . . . The media tag may then be communicated with the media module 12 that is an element of the 3^{rd} party application and data management server 10. The dynamic data management element or module 18 can then analyze factors such as the type of content that was tagged, whether the additional landing page 38 watched it or commented on it. The dynamic data management module 18 may then direct similar media content, link the landing pages 20 & 28 through the 3^{rd} party server 10 to other users whose behavior indicates similar interests or direct related or direct advertising or other producer related materials to the users based on the data analysis.

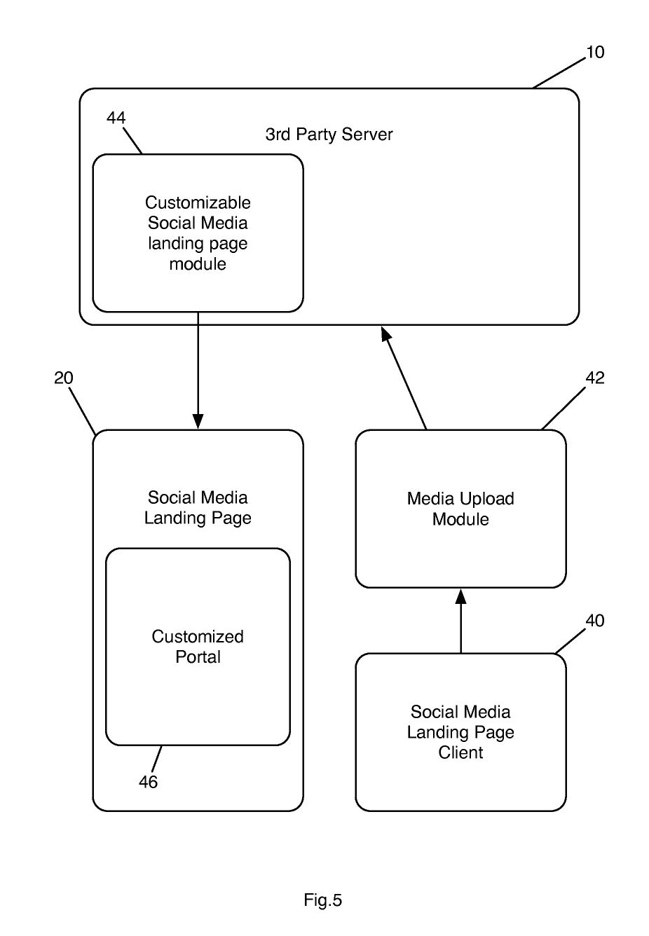

FIG. 5 illustrates a means for a producer/manufacturer client to upload media to the provider 3^{rd} party server 10 and ultimately to the user's social media landing page 20. In this embodiment it is envisioned that the client also utilizes a social media landing page 40 customized to permit the uploading of media to the 3^{rd} party server 10. This is a feature that the 3^{rd} party provider could feasibly make available to anyone. In this embodiment the provider envisions a corporate client that would engage the 3^{rd} party provider to provide their generated media content, but the 3^{rd} party provider could make the media content upload feature available to users as well on a pay per submission basis or freely available as it suited the needs of the present invention. In this illustration a client or producer of media content uploads the content, such as a video, from their landing page 40 through a media upload module 42 to the 3^{rd} party server. The 3^{rd} party that is providing the present invention then may use a customization module 44 in order to provide a unique format to the html content linked to the user's social media landing page 20. When the user of the landing page 20 selects media content from the particular client 40 that media may be displayed in a customized portal 46 through the present invention. Features might include a customized background of stable or transitioning media highlighting products or information the client wishes to convey to the consumer of its media. The customization may also extend to adding the utility of specific features in addition to chat such as the ones illustrated in FIG. 3 or additional features such as e-commerce options to purchase goods or services from the client of the invention provider or to redeem promotions. Essentially the portal may become the client's electronic storefront and communications portal with the users of the present invention. The larger the user base of the present invention, the greater the audience that can be provided to clients.

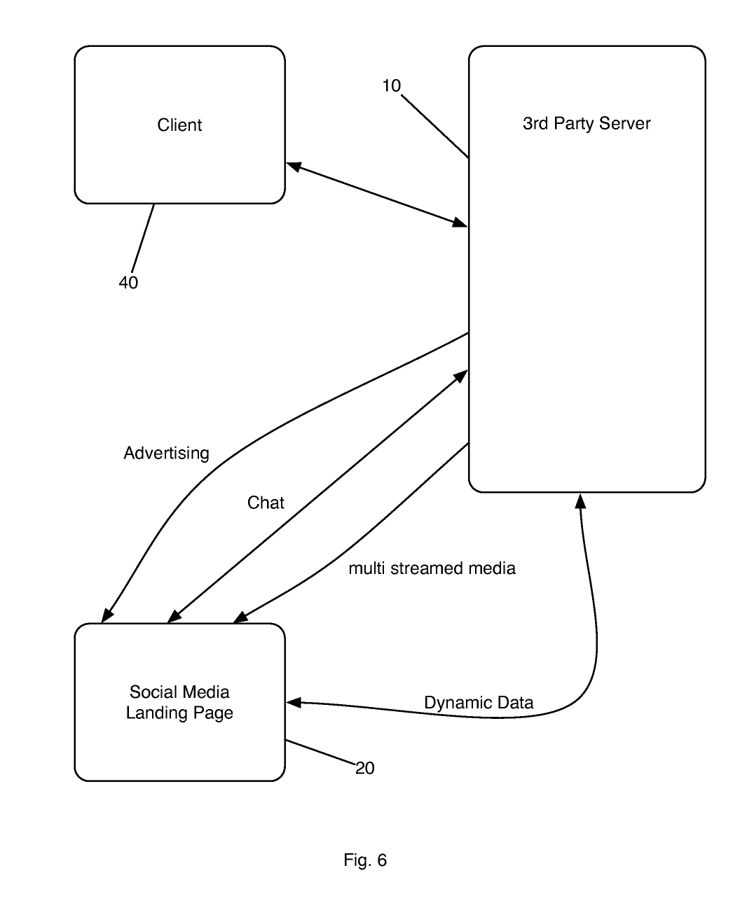

FIG. 6 further illustrates an embodiment of the relationship between the client 40 who produces the media, the 3^{rd} party server 10 that provides the present invention and the user's social media landing page 20 that provides the mechanism through which the user accesses the present invention. This figure further displays some of the central elements of the invention: multi streamed media, chat, and dynamic data analysis. Multi streamed media can be provided in numerous contexts, but in one preferred embodiment the streamed media may be in a tiered format. That is, there may be multiple related broadcasts with a master broadcast, sub-broadcasts and sub broadcasts of those: a kind of parent-child-grandchild format. By way of example, the client could be broadcasting the America's Cup sailing race. The “parent” broadcast might be the overall race itself, but simultaneously the broadcaster may stream “child” or sub broadcasts from the deck of each boat in the race. It might also simultaneously broadcast “grandchild” broadcasts containing content related to each of the sponsors of each boat. This kind of simultaneous related broadcasting gives the user the opportunity to essentially zoom in or out depending on their interest in the content and quickly find out more about, for example, the people, companies and products behind their favorite boat in a race.

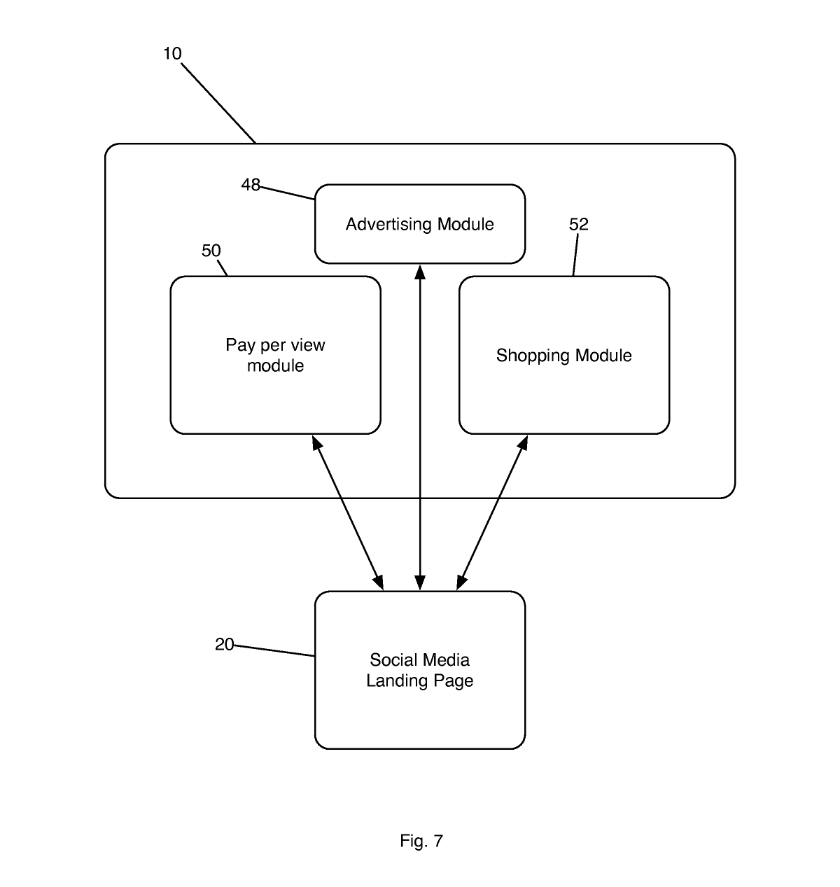

FIG. 7 illustrates a further example of modules that may be incorporated into the 3^{rd} party server platform 10 to enable various features of the present invention. A module to direct advertising 48, a pay per view module 50 or an e-commerce shopping module 52 are shown to illustrate a sample of the types of services the present invention may provide to clients and directed to the users social media landing pages 30. These modules may be in communication with the dynamic data management module 18 that enables the client producers of the media, through the provider of the present invention, to correlate and direct targeted services based on the metadata collected from the users of the system provided by the present invention.

The third party server 10 of the present invention may be implemented in numerous ways. It may take the form of a physical collection of hardware based servers or computers operating on a variety of computer language based systems or it may be alternatively based on a system of virtual servers such as a cloud based system or any other system that provides similar computing resources. The system may also be accessed, as in the described preferred embodiment, by social media landing page 20 within a social media server 22 such as Facebook or from any other conceivable Internet based web page or access point such as: a cellphone utilizing various languages such as Apple IOS or Google Android, or by a desktop computer. The permissions module 24 as described is not meant to be taken in a limiting fashion, but instead illustrates one means for a user to allow the 3^{rd} party system 10 to access and provide services to the user of a secondary subscribed system such as Facebook, Twitter, Pinterest or other platform that may provide a platform for the present invention to operate through.

A sample of other features that may be provided by the present invention include “clear layer technology” whereby a user may interactively use their computer to click on or select areas of interest on the area of the screen where audio/video media is being provided to indicate or select parts of the media that are of interest thereby triggering added services or providing metrics to the provider of the present invention that can be dynamically responded to or evaluated to further the services provided by the present invention. The user may also overlay or manipulate content to superimpose video chat or commentary or user media that may be permitted by the provider. The provider of the present invention may also link or incorporate the services of other invention providers or other Internet networks or websites to provide users and client producers with increased resources and services. It should be recognized that embodiments of the present invention may use any one or more of these optional aspects in substantially any combination, without departing from the scope of the present invention. A further conceived embodiment may also provide a user based producer system. In this embodiment, users would act as both producer and user whereby media is generated by a user, uploaded to the 3^{rd} party server 10 which distributes the media as previously described generating metrics and meta data dynamically analyzed and acted upon by the present invention. Furthermore, data transferred and analyzed (such as chat) may be processed through the third party server as described or, by agreement, through other web platforms such as a social media website that may provide the metadata and linked networking otherwise obtained directly through the third party server of the present invention. The present invention has largely been described as linking a media player to a landing page. It is also possible for the functionality of the invention to be achieved by embedding the media player or other elements or modules of the 3^{rd} party application and data management server 10 within the landing page itself or the platform within which the landing page resides such as a social media server 22.

The 3^{rd} party server 10 is illustrated in the form of a computer system within which a set of instructions, for causing a machine to perform any one of the methodologies discussed above, may be executed. In alternative embodiments, the machine may include a network router, a network switch, a network bridge, Personal Digital Assistant (PDA), a cellular telephone, a web appliance, cloud computing or any system capable of executing a sequence of instructions that specify actions to be taken by that machine.

The 3^{rd} party server 10 includes a computer-readable medium on which is stored a set of instructions (i.e., software) embodying any one, or all, of the methodologies described above. The software may reside, completely or partially, within a main memory storage device and/or within a processor. The software may further be transmitted or received via a network interface device. For the purposes of this specification, the term “computer-readable medium” shall be taken to include any medium that is capable of storing or encoding a sequence of instructions for execution by the computer and that cause the computer to perform any one of the methodologies of the present invention. The term “computer-readable medium” shall accordingly be taken to include, but not be limited to, solid-state memories, virtual storage or cloud based systems, optical and magnetic disks, and carrier wave signals.

Thus, a method and apparatus for integrating media, chat and dynamic data management has been described. Although the present invention has been described with reference to specific exemplary embodiments, it will be evident that various modifications and changes may be made to these embodiments without departing from the broader spirit and scope of the invention. Accordingly, the specification and drawings are to be regarded in an illustrative rather than a restrictive sense.

Furthermore, embodiments of the present invention may include a computer program code-based product, which includes a computer readable storage medium having program code stored therein which can be used to instruct a computer to perform any of the functions, methods and/or modules associated with the present invention. The computer storage medium includes any of, but not limited to, the following: CD-ROM, DVD, magnetic tape, optical disc, hard drive, floppy disk, ferroelectric memory, flash memory, ferromagnetic memory, optical storage, charge coupled devices, magnetic or optical cards, smart cards, EEPROM, EPROM, RAM, ROM, DRAM, SRAM, SDRAM, cloud based systems and/or any other appropriate static, dynamic memory, virtual or data storage devices.

It should be noted that the various modules and other components of the embodiments discussed hereinabove may be configured as hardware, as computer readable code stored in any suitable computer usable medium, such as ROM, RAM, flash memory, phase-change memory, magnetic disks, virtual cloud technology etc., and/or as combinations thereof, without departing from the scope of the present invention.

It should be further understood that any of the features described with respect to one of the embodiments described herein may be similarly applied to any of the other embodiments described herein without departing from the scope of the present invention.

In the preceding specification, the invention has been described with reference to specific exemplary embodiments for the purposes of illustration and description. It is not intended to be exhaustive or to limit the invention to the precise form disclosed. Many modifications and variations are possible in light of this disclosure. It is intended that the scope of the invention be limited not by this detailed description, but rather by the claims appended hereto.

The above systems are implemented in various computing environments. For example, the present invention may be implemented on a conventional IBM PC or equivalent, multi-nodal system (e.g., LAN) or networking system (e.g., Internet, WWW, wireless web). All programming and data related thereto are stored in computer memory; static, virtual or dynamic or non-volatile, and may be retrieved by the user in any of the conventional means of computer storage display (e.g., CRT, flat panel LCD, plasma, etc.) and/or hardcopy (i.e., printed) formats. The programming of the present invention may be implemented by one skilled in the art of computer systems and/or software design.

Having thus described the invention, what is claimed is:

1. A computer implemented system in a client server environment for the display of media, communications of said media between users and dynamic analysis of said media, the system comprising:
a third party server including:
a software package downloadable to an internet based platform;
a database of downloadable media content;
a dynamic data analysis module;
said software package configured to:
provide a media platform linked to an existing internet platform;
integrate said media platform with chat capabilities;
provide media content managed by the third party server;
enable sharing of media content through a network of linked chat rooms created by the third party server;
said dynamic data analysis module configured to:
manage media content by dynamic data analysis of data generated by the third party server.

2. A computer implemented system in a client server environment for the display of media, communications of said media and dynamic analysis of said media within a social media landing page, the system comprising:
a third party server including:
a software package downloadable to an internet based social media platform;
a database of downloadable media content;
said software package configured to:
provide a media platform within a social media landing page;
integrate said media platform to real-time chat rooms;
provide media content managed by the third party server;
enable sharing of media content through a social media network;
said dynamic data analysis module configured to:
actively manage media content by dynamic data analysis through the third party server.

3. The system of claim 2, further comprising:
where the downloadable media content is multiple streaming audio video feeds.

4. The system of claim 3, further comprising:
where said dynamic data analysis enables the third party server to respond actively to viewer behavior by providing additional relevant information or features to the social media landing page.

5. The system of claim 4, further comprising:
a pay per view option for accessing media data from the third party server.

6. The system of claim 5, further comprising:
an integrated shopping module to purchase products displayed.

7. The system of claim 6, further comprising:
an advertising module configured to integrate advertising from the third party server into the media platform.

8. The system of claim 7, further comprising:
a client module within the third party server providing a platform for customers to build customizable dynamic internet portals transferable to the social media landing page.

9. The system of claim 8, further comprising:
allowing the user to tag media content.

10. The system of claim 9, further comprising:
the third party server dynamically altering the appearance of the media platform on a social media landing page in response to its data analysis.

11. The program as in claim 10 further configured to allow a content provider to target individual chat room viewers of multimedia content and engage individually with them in a chat room.

12. The program as in claim 11 further configured to dynamically collect data on viewing trends during a multimedia broadcast.

13. The program as in claim 12 further configured to dynamically collect data on chat room content across linked chat rooms during a multimedia broadcast and analyze trends in the content of said chat rooms.

14. The program as in claim 13 further configured to allow a content provider to target group and individual chat room viewers of multimedia content and engage a plurality of users or individuals in a chat room.

15. The program as in claim 14 further configured to allow multiple multimedia providers to simultaneously provide multiple related audio video feeds and direct viewers to related multimedia content through chat rooms and advertisement and the media platform.

16. A computer implemented method in a client-server environment, for providing real time media content to an integrated media platform accessible within a social media landing page, the method comprising:
at the server:
(a) capturing media data;
(b) capturing a customizable client webpage;
(c) providing access to software to a user of a social media internet website for integration into that social media platforms user landing page;
(d) at the landing page the software providing streaming media content;
(e) at the landing page the embeddable software linking the streaming media content to integrated chat rooms.
At the landing page the software recording data provided by the user and related users to the server, and that data being dynamically analyzed and responded to by said server by subsequent alterations of the media, elements of the landing page, utility options and other features and modules available through the landing page.

17. The method of claim 16 where said modules include a pay per view module.

18. The method of claim 17 where said modules include a product purchase module.

19. The method of claim 18 where said modules include an advertising module.

20. The method of claim 19 where captured media data is provided by the user.
